(19) United States
(12) Patent Application Publication
(10) Pub. No.: US 2026/0119605 A1
(43) Pub. Date: Apr. 30, 2026

(54) METHOD AND SYSTEM FOR MATRIX REDUCTION IN LARGE LANGUAGE MODELS

(71) Applicant: Cornami, Inc., Dallas, TX (US)

(72) Inventors: Fa-Long Luo, Dallas, TX (US); Paul L. Master, Dallas, TX (US)

(21) Appl. No.: 19/368,779

(22) Filed: Oct. 24, 2025

Related U.S. Application Data
(60) Provisional application No. 63/711,469, filed on Oct. 24, 2024.

(51) Int. Cl. G06F 17/16; G06N 3/0475

(52) U.S. Cl. CPC G06F 17/16; G06N 3/0475

(57) ABSTRACT

The disclosure is directed toward a method to efficiently perform a large language model operation by reducing the memory and computation resources for operating on a matrix such as a weight matrix. The weight matrix may be included in operations such as the head attention function of the large language model. The weight matrix is decomposed into multiple submatrices that each include a set of weights from the weight matrix. An input of the large language model is provided. A submatrix solution for the submatrix is determined from the input and the set of weights of the submatrix. The determining of a solution is repeated for each of the submatrices to provide multiple submatrix solutions. The resulting submatrix solutions are combined to obtain a matrix solution for the weight matrix.

### PRIORITY CLAIM

The present disclosure claims the benefit of and priority to U.S. Provisional Application Ser. No. 63/711,469, filed on Oct. 24, 2024. The contents of that application are hereby incorporated by reference in their entirety.

### TECHNICAL FIELD

The present disclosure relates generally to large language models (LLMs). More particularly, aspects of this disclosure relate to an efficient method of performing an attention function by reducing matrices.

### BACKGROUND

Large Language Model (LLM) and Generative Pre-trained Transforms (GPT) technology based Generative Artificial Intelligence (GenAI) is now finding uses in almost every aspect of industry and society due to powerful capabilities in extracting, processing and expanding data, information and knowledge. GenAI can help to meet increasing digital demands in terms of cost, power, capacity, coverage, latency, efficiency, flexibility, compatibility, quality of experience and silicon convergence.

A LLM may be considered as a nonlinear mapping from the input X (a query) and to output Y (a response) by performing the following major processing blocks shown in FIG. 1. The major processing blocks thus include Embedding and Encoding 10, Multiple Head Attention 12, Feed Forward Perceptron 14, Layer Normalization 16 and Softmax functions 18. In a LLM layer as shown in FIG. 1 the Embedding and Encoding 10 is a pre-processing unit which mainly performs the matrix multiplications between the input matrix and the corresponding weight matrices. The Multiple Head Attention 12 performs multiple matrix multiplications according to three weight matrices termed a Query Matrix 20, a Key Matrix 22, and a Value Matrix 24, respectively. The Feed Forward Perceptron layers 14 constitute a conventional feedforward neural network having at least one hidden layer. The Layer Normalization 16 simply normalizes each input. The Softmax functions 18 is an activation function that scales numbers/logits into probabilities.

The output of a LLM can uniquely be generated by all the pre-determined weight matrices and its inputs. These weight matrices can be obtained during an off-line training stage. During an inference stage, LLM simply performs all the above matrix multiplications and corresponding nonlinear functions such as layer normalization and Softmax operations. Different LLMs have different parameter sizes (the total element number of the weight matrices), which mainly depend on the numbers of attention heads and number of LLM layers. For example, GPT-3 has 96 heads and 96 layers and hence there are about 175 billion parameters (elements of weight matrices) in total.

In terms of training and inference, the applications and implementation scenarios of LLM may be mainly categorized into the following three groups, namely: 1) General LLMs; 2) Fine-Tuned LLMs; and 3) Private LLMs. A general LLM is the LLM that is most commonly used. In a general LLM, the processing steps include: 1) a Client sending their data X to the party operating the server that owns LLM parameters; 2) the Server performing the LLM operation with the data X as inputs of the LLM as shown in FIG. 1; and 3) the Server sending the Client the generated output Y, which equals F (W, X). In this example, W denotes the entire weight matrix and F (W, X) represents the nonlinear mapping that the LLM is to perform.

It is possible to perform processing using very specific knowledge to produce LLMs that are experts in a narrow knowledge domain by taking the existing pre-trained general LLM as a starting point. The use of the specific knowledge combined with a general LLM results in a Fine-Tuned LLM. A Fine-Tuned LLM involves taking a pre-existing general model that has been trained on a large dataset, such as a language model like GPT-3, and refining the general model for a specific task or domain. During fine-tuning, the model is further trained on a smaller, domain-specific dataset. This process adapts the parameters of the model to the nuances of the target task, improving its performance and making it more capable in handling specific tasks. Fine-tuned LLMs are a cost-effective and efficient way to leverage the knowledge learned by a pre-trained general model while tailoring the general model to specific applications. This reduces the need for extensive training from scratch. Fine-tuned LLMs allow for rapid development of domain specific AI solutions with high accuracy and applicability.

More specifically, the processing steps of a fine-tuned LLM include: 1) a Client sending their data X to a party operating the server with LLM parameters and fine-tuned parameters; 2) the Server performing the LLM operation with the data X as inputs of the Fine-Tuned LLM; and 3) the Server sending the generated output Y to the Client. The generated output, Y, may be represented by F(W, X)+F(ΔW, X) or F(W+ΔW, X).

In the above explained for General LLMs and Fine-Tuned LLMs, both the client and the server are fully transparent and there is neither privacy, protection, or security for the client input data, resulting output data, and the customized fine-tuning parameters owned by the server operator. Hence, there are three problems regarding privacy and data protection when using either model.

From the perspective of the owner of the fine-tuned LLM model, the theft of one of these fine-tuned LLM parameters is catastrophic. The LLM parameters can enable competitors to produce products or offer services that compete with the owner of the LLM. Such information may also be simply released on the internet and thus drive the revenue of the LLM owner to zero. There is therefore a need to prevent the access and use by unauthorized third parties of a proprietary fine-tuned LLM.

A client of a party that owns such LLMs provides queries to the LLM owner and receives results from these queries from the LLM owner. The queries from the client may contain intellectual property and the answers to these queries may also contain new and novel intellectual property that the owner of the LLM now has access to. There is a need to prevent the unauthorized disclosure of intellectual property of a client into the LLM from the user queries as well as a need to protect any new and novel intellectual property from the responses of the LLM.

The information that is used for fine-tuning the LLM may be highly sensitive, proprietary, classified or protected under privacy laws such as European GDPR rules or U.S. HIPPA rules. There is thus a need to be able to perform training of LLMs without exposing the training information during the fine-tuning process. Such information may be protected by encryption.

Currently, encryption techniques relate to public/private key mechanisms that require an intensive level of computing power to brute force solve the encryption. Such systems are currently secure because of the corresponding intensive level of computing power necessary to crack such encryption. However, with the potential advent of quantum computers, standard encryption techniques may be vulnerable to being solved by a quantum computer. Thus, new types of quantum secure encryption have been proposed, such as fully homomorphic encryption (FHE). FHE allows computations on ciphertext without having to perform decryption. This allows delegation of sensitive data analysis computations on encrypted data. There are several open-source frameworks of fully homomorphic encryption. One such framework is the Concrete library that implements the Fully Homomorphic Encryption over the Torus (TFHE) procedure. A second framework is OpenFHE, which supports multiple schemes including Brakerski Gentry Vaikun-Tanathan (BGV), Brakerski/Fan-Vercauteren (BFV), Cheon-Kim-Kim-Song (CKKS), TFHE, and FHEW.

An example FHE operation is a Partial Result Sharing Approach for two parties, which is functionally equivalent to a (2,2) threshold approach. The first party generates their own FHE public key (PK1) and FHE private key (SK1) for their database. The second party generates their own FHE public key (PK2) and FHE private key (SK2) for their database. The public keys, PK1 and PK2 are shared between the parties, while the private keys, SK1 and SK2 are kept secret.

A Joint Key (JK) is computed using the public keys PK1 and PK2. This key is neither a secret key nor a public key in the traditional sense but serves as a unified platform facilitating joint computations on encrypted data. Evaluation keys, associated with the joint key, are generated. These evaluation keys are crucial for operations like “addition” and “multiplication” in the homomorphic encryption domain. Thus, the first party may encrypt its data (Data1) with PK1, resulting in Ciphertextdb1. The second party may encrypt its data (Data2) with PK2, resulting in Ciphertextdb2.

A process often referred to as key switching is applied. Key switching converts Ciphertextdb1 and Ciphertextdb2 to be compatible with the joint key (JK), allowing for homomorphic operations without revealing the actual data. After Ciphertextdb1 & Ciphertextdb2 are key switched to be under the joint key, the first party can no longer decrypt Ciphertextdb1 using only SK1, and the second party can no longer decrypt Ciphertextdb2 using only SK2. Thus, both parties must collaborate to decrypt the respective ciphertexts. Computations (such as addition, multiplication, etc.) may be performed on the encrypted data. These operations are executed under the joint key, ensuring consistency and validity. After computations, the process for joint decryption begins, ensuring that neither the public keys, SK1 nor SK2, are exposed to the other party.

The Concrete library is an open-source library developed in Rust that builds on the state-of-art TFHE cryptosystem. The Concrete library provides a user friendly interface making FHE easy to integrate. The Concrete library deals with inputs of arbitrary format and comes with an extensive set of operations for manipulating ciphertexts, including a programmable bootstrapping process. Learning With Errors (LWE) is a quantum robust method of cryptography applicable to FHE. The LWE problem is conjectured to be hard to solve, and thus to be useful in cryptography. FHE is based on a quantum secure scheme for the LWE (learning with errors) problem. The FHE allows computations such Boolean operations, Integer arithmetic operations, and floating-point arithmetic operations on ciphertext without decryption. Thus, sensitive data analysis (computations) may be performed on encrypted data without ever decrypting the data.

In theory, privacy could actually be accomplished by using fully homomorphic encryption (FHE) approaches, but this approach is too computationally cumbersome for conventional hardware such as graphic processor units (GPU)s.

According to different requirements for privacy and security, private LLMs can be grouped into three levels by taking different data format (plaintext or ciphertext) for input query, weights and output responses of a LLM.

A Level 1 private LLM encrypts input queries and output responses but leaves general weights in plaintext. The Level 1 private LLM does not incorporate fine-tuning. A Level 2 private LLM encrypts input queries and output responses, but leaves fine-tuning and general weights in plaintext. A Level 3 private LLM encrypts input queries, output responses, and fine-tuning weights, but leaves general weights in plaintext. The additional encryption required as well as the other computational operations required makes each successive level of the private LLM more impractical for current hardware.

Thus, there is a need for a method to facilitate computations for the attention function for an LLM. There is a further need for reducing the memory required for executing an attention function for an LLM.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One disclosed example is a method to perform an attention head function. A weight matrix is decomposed into a plurality of submatrices, each including a set of weights from the weight matrix. An input of the attention head function is provided. One of the plurality of submatrices is stored in a storage device. A submatrix solution for the submatrix is determined from the input and the set of weights of the submatrix. The storing and determining a solution for the submatrix is repeated for each of the plurality of submatrices to provide a plurality of submatrix solutions. The resulting plurality of submatrix solutions is combined to obtain a matrix solution for the weight matrix.

A further implementation of the example method is where the matrix solution is an input to a large language model. Another implementation is where the weight matrix is one of a key matrix, a query matrix or a value matrix. Another implementation is where g submatrices are created, where the weight matrix has an L×L dimension, and where each of the submatrices has an L×h dimension, and where g×h=L. Another implementation is where the storage device is a high bandwidth memory. Another implementation is where the determining a submatrix solution is performed by a processing core of a plurality of processing cores. Another implementation is where the attention head function is part of a transformer based large model.

Another disclosed example is a computer system including a memory and an input accepting an input to an attention head function. A processor is coupled to the input and the memory. The processor is configured to decompose a weight matrix into a plurality of submatrices, each including a set of weights from the weight matrix. The processor is configured to store a set of weights from one of the submatrices in the memory. The processor is configured to determine a submatrix solution for the submatrix from the input and the set of weights of the submatrix. The processor is configured to repeat the storing a set of weights and determining a solution for the submatrix for each of the plurality of submatrices to provide a plurality of submatrix solutions. The processor is configured to combine the resulting plurality of submatrix solutions to obtain a matrix solution for the weight matrix.

A further implementation of the example computer system is where the matrix solution is an input to a large language model. Another implementation is where the processor includes a plurality of identical configurable processing cores and a network interconnecting the plurality of identical configurable processing cores. Another implementation is where the matrix solution is an input to a large language model. Another implementation is where the weight matrix is one of a key matrix, a query matrix or a value matrix. Another implementation is where g submatrices are created, wherein the weight matrix has an L×L dimension, and wherein each of the submatrices has an L×h dimension, and wherein g×h=L. Another implementation is where the memory is a high bandwidth memory. Another implementation is where the attention head function is part of a transformer based large model.

Another disclosed example is a non-transitory computer readable medium including executable instructions which, when executed in a processor, causes the processor to decompose a weight matrix into a plurality of submatrices, each including a set of weights from the weight matrix. The instructions cause the processor to store a set of weights from one of the submatrices in the memory. The instructions cause the processor to receive an input to an attention head function. The instructions cause the processor to determine a submatrix solution for the submatrix from the input and the set of weights of the submatrix. The instructions cause the processor to repeat the storing a set of weights and determining a solution for the submatrix for each of the plurality of submatrices to provide a plurality of submatrix solutions. The instructions cause the processor to combine the resulting plurality of submatrix solutions to obtain a matrix solution for the weight matrix.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1 is a diagram of a prior art LLM layer with different operations;

FIG. 2A is a diagram of a chip having four dies each having multiple processing cores;

FIG. 2B is a simplified diagram of one of the dies on the chip shown in FIG. 2A;

FIG. 3A is a block diagram of the array of cores in the die in FIG. 2B;

FIG. 3B is a three-dimensional view of the array of cores in the die in FIG. 2B;

FIG. 4 is an example reconfigurable arithmetic engine configuration of one of the cores in the core array in FIG. 2A;

FIG. 5A is a diagram of configurations of the array of cores in FIG. 2A as either a RISC-V or a specialized ALU internal module;

FIG. 5B is a diagram of several dies mapped to a topology configured to perform different functions;

FIG. 6 is a prior art implementation of the attention function mechanism in FIG. 1; and

FIG. 7 is an example implementation of the attention function in FIG. 1 that relies on matrix reduction for more efficient computation and reduced memory use.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The disclosure is directed toward a method to efficiently perform a large language model operation by reducing the memory and computation resources for solving a matrix such as a weight matrix. The weight matrix may be included in operations such as the head attention function of the large language model. The weight matrix is decomposed into multiple submatrices that each include a set of weights from the weight matrix. An input of the large language model is provided. A submatrix solution for the submatrix is determined from the input and the set of weights of the submatrix. The determining of a solution is repeated for each of the submatrices to provide multiple submatrix solutions. The resulting submatrix solutions are combined to obtain a matrix solution for the weight matrix.

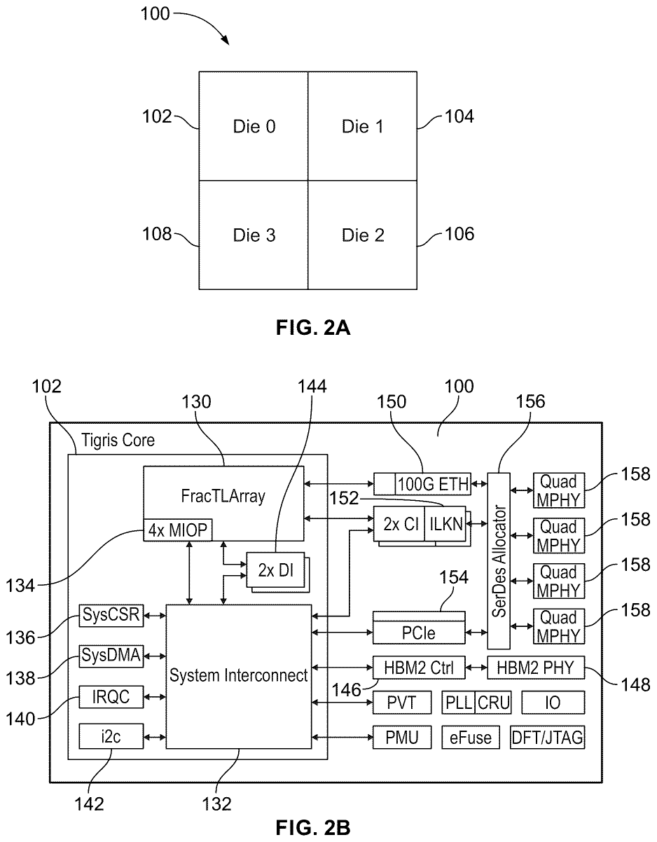

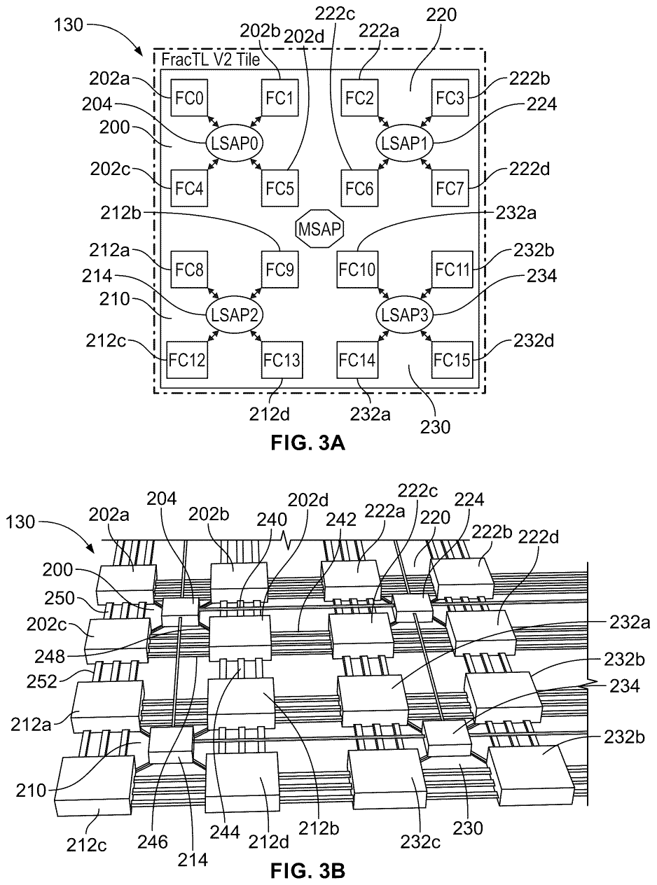

FIG. 2A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 2B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 2A.

The chip includes a high bandwidth memory controller 146 coupled to a high bandwidth memory 148 that constitutes an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory IO processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

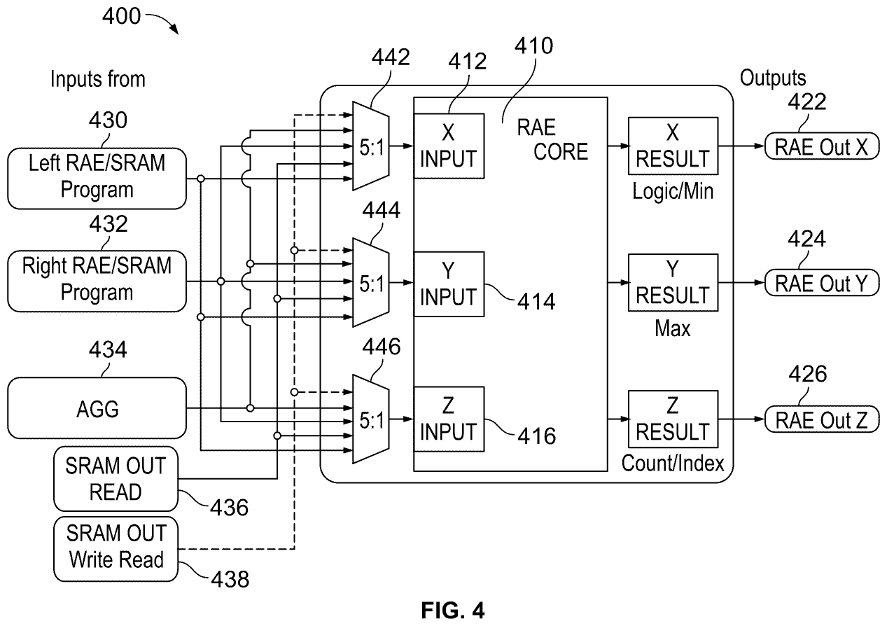

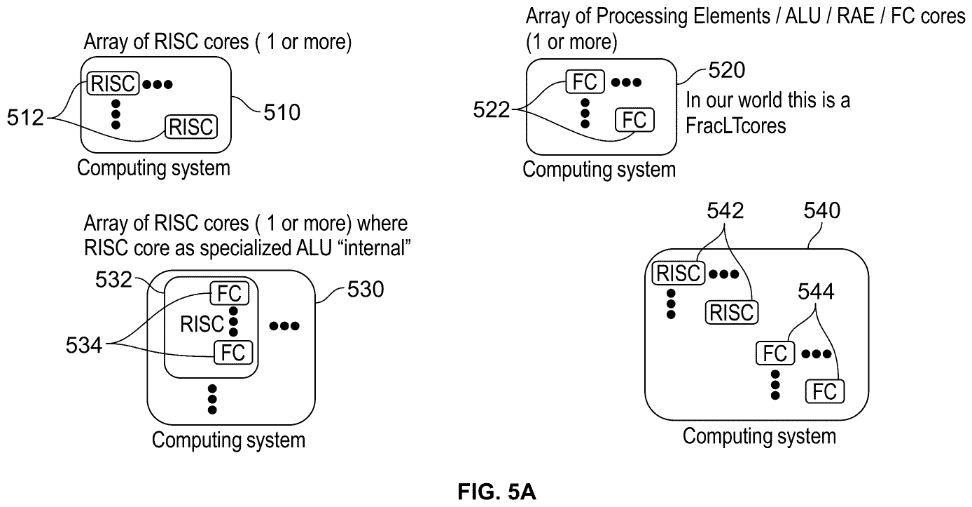

FIG. 3A is a detailed diagram of the array of cores 130 in FIG. 3B. FIG. 3B is a three-dimensional image of the array of cores 130 in FIG. 3B. The array of cores 130 is organized into four core clusters such as the clusters 200, 210, 220, and 230 shown in FIG. 3A. For example, the cluster 200 includes cores 202a, 202b, 202c, and 202d. Each of the four cores in each cluster 200 such as cores 202a, 202b, 202c, and 202d are coupled together by a router 204. FIG. 3B shows other clusters 210, 220, and 230 with corresponding cores 212a-212d, 222a-222d and 232a-232d and corresponding routers 214, 224, and 234.

As may be seen specifically in FIG. 3B, in this example, each of the cores 202a, 202b, 202c, and 202d has up to four sets of three interconnections [L, A, R]. For example, a core in the center of the array such as the core 202d includes four sets of interconnections 240, 242, 244, and 246 each connected to one of four neighboring cores. Thus, core 202b is connected to the core 202d via the interconnections 240, core 202c is connected to the core 202d via the interconnections 242, core 212b is connected to the core 202d via the interconnections 244, and core 202c is connected to the core 202d via the interconnectors 246. A separate connector 248 is coupled to the wire router 204 of the cluster 200. Thus, each core in the middle of the array, has four sets of interconnections, while border cores such as the core 202c only have three sets of interconnections 250, 252, and 246 that are connected to respective cores 202a, 202d, and 212a.

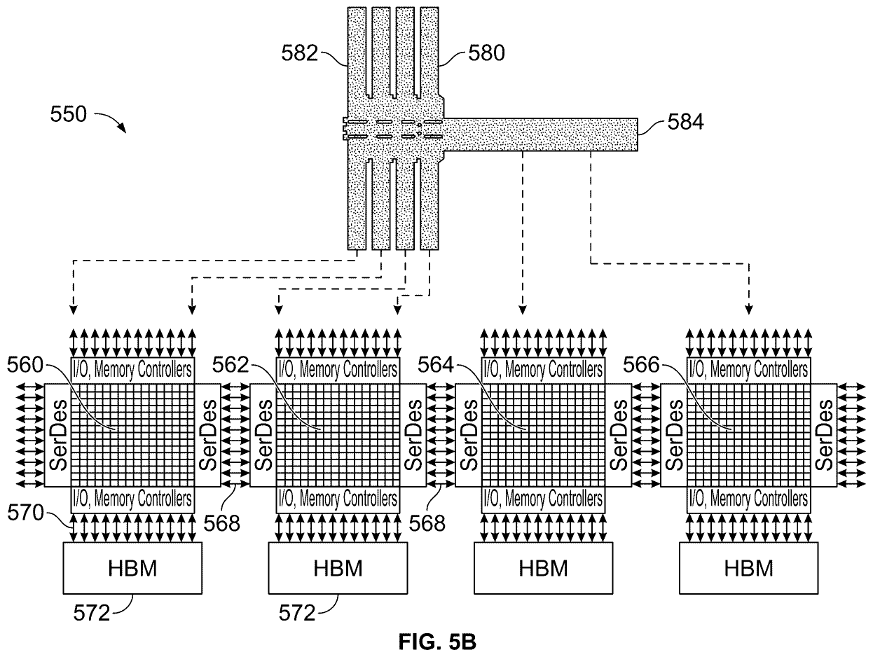

In order to configure the cores of the example array 130 in FIG. 2A, the inputs of certain blocks may be changed to configure blocks for one of the three different function blocks. The functions may be configured by simply changing the inputs of the processing cores. FIG. 4 shows a block diagram of an example processing core 400 that includes a reconfigurable arithmetic engine (RAE) 410. The RAE 410 may be configured and reconfigured to perform relevant mathematical routines such as matrix multiplications, point wise multiplication and nonlinear functions, such as layer normalization and a Softmax function, required in private LLM. The RAE 410 includes input reorder queues, a multiplier shifter-combiner network, an accumulator and logic circuits. The RAE 410 operates in several modes, such as operating as an ALU, and include a number of floating point and integer arithmetic modes, logical manipulation modes (Boolean logic and shift/rotate), conditional operations, and format conversion. The RAE 410 includes three inputs 412, 414, and 416 and three outputs 422, 424, and 426. The RAE 410 receives the output data from a program executed by another RAE 430 and output data from another program executed by another RAE 432. An aggregator (AGG) 434 provides an output of aggregated data from different sources to the RAE 410. A memory read output 436 and a memory write output 438 also provide data to the RAE 410. The memory outputs 436 and 438 provide access to a memory such as an SRAM that stores operand data, and optionally may also store configurations or other instructions for the RAE 410.

Each of the output data of the RAE 430, RAE 432, aggregator 434, memory read output 436 and the memory write output 438 are provided as inputs to three multiplexers 442, 444, and 446. The outputs of the respective multiplexers 442, 444, and 446 are coupled to the respective inputs 412, 414, and 416 of the RAE 410.

There are two versions of configurations of computational cores which can dynamically switch from one type to the other. A set of cores may be configured as a full RISC-V processor with associated SRAM able to execute traditional control flow programs as a function representing the computation within a dataflow node. RISC-V for Legacy code is supported by configuring multiple cores under software control. This may be used to produce software GPUs or other types of cores from the multiple cores. The processing cores such as the FracTLcores offered by Cornami are an efficient set of transistors for streaming data driven workloads, with a dynamic programming scheduler such as the TruStream programming scheduler offered by Cornami and memory, created from a set of RAE Cores. In this example, the FracTLcores can scale up to 64,000,000 cores across chips and systems at near linear scale. Combining the aspects of both data flow and reconfigurable computing to stream data, this architecture with highly functional computational elements can dynamically scale over many chips. It enables developers to take full advantage of both parallelism and pipelining to minimize processing latency and maximize overall application performance and throughput. The use of the architecture of processing cores results in reduction in processing cost. The cores may employ a data-flow programming model resulting in a 5× reduction in processing cost. A data-defining-function computation for the cores may result in a 6× reduction in processing cost. A data Read/Write with a Tensor pattern applied to the cores may result in a 6× reduction in processing cost.

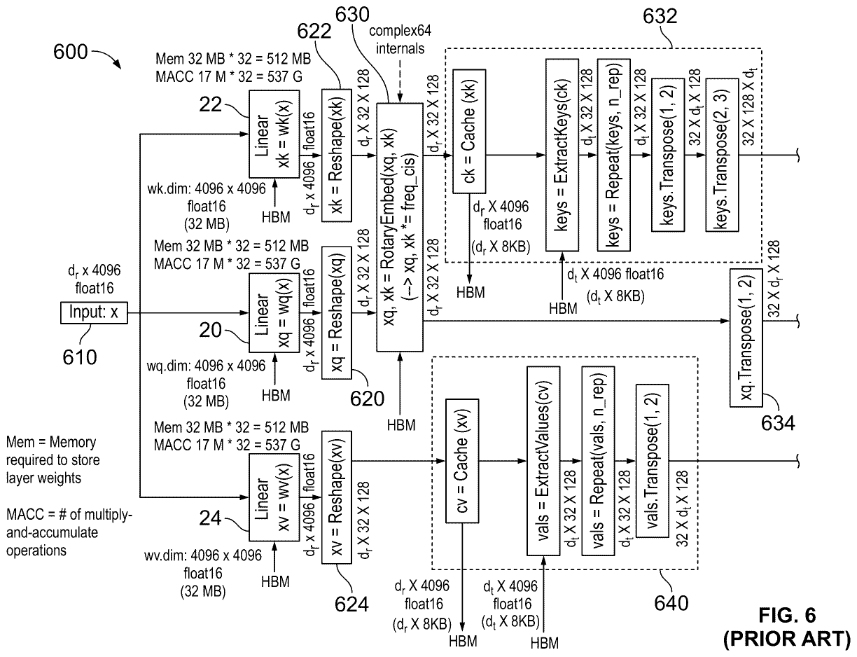

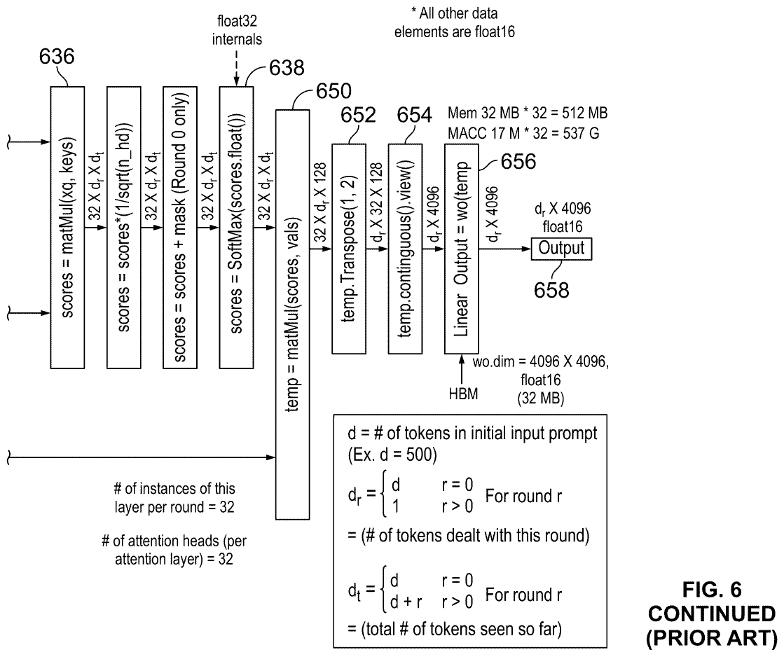

FIG. 5A is a diagram of four configurations 510, 520, 530, and 540 of the array of cores in FIG. 2B as either a RISC-V processor or a specialized ALU internal module. The configurations 510, 520, 530, and 540 can dynamically switch from one type to the other by reconfiguring some or all of the computational cores in the configurations. The first configuration 510 is a set of cores configured as a full RISC processor with associated SRAM able to execute traditional Control Flow programs as a function representing the computation within a dataflow node. In this example, the RISC processor includes sixteen separate cores 512. Another configuration 520 is sixteen independently reconfigurable and programmable ALUs, that are each cores 522 (termed FracTLcores® available from Cornami in this example). Each of the cores 522 have associated SRAM supporting multiple simultaneous integer and floating point computations of up to 128-bits. The configuration 520 thus is a set of cores that are configured as individual FracTLcores. The configuration 530 includes one or more RISC cores 532 that are a set of sixteen cores in this example. The RISC core 532 can have additional individual or multiple FracTLcores 534 incorporated within them to accelerate specific RISC functions. Alternatively, the additional cores 534 may be designated for data path/arithmetic acceleration, enhancing ALU performance.

Thus, to implement a standard 64 bit RISC processor such as the RISC-V processor in this example, sixteen cores are configured to become the RISC-V. Optional additional cores may be added to the configuration to provide hardware acceleration to math operations performed by the RISC. For example, a normal RISC processor does not have hardware to perform a cosine function. Thus, an additional core may be added and configured to perform a hardware cosine operation. This enhances the ISA instruction set of the RISC processor by adding the hardware accelerated cosine function that may be accessed by the RISC processor. The configuration 540 has a set of cores that is configured into two individual groupings of cores configured as RISC processors 542 and cores that are configured as ALUs (e.g., FracTLcores) 544.

FIG. 5B is a block diagram of an example architecture 550 of scaling circuits using four integrated circuits 560, 562, 564, and 566 that are coupled to memory controllers and external memories. The integrated circuits 560, 562, 564, and 566 may be formed on a die and each include an array of cores described above in reference to FIGS. 2-3. Each of the individual integrated circuits 560, 562, 564, and 566 are connected to each other using SERDES interconnections 568 to produce larger computational fabrics. Each core may be individually configured such as those configurations shown in FIG. 4A. The cores are interconnected via the network on chip components shown in FIGS. 2A-2B. Each of the integrated circuits 560, 562, 564, and 566 also include input/output interconnections 570 that may be controlled by a memory controller such as the memory input/output processors 134 in FIG. 2B to manage a connected high bandwidth memory devices such as an HBM die 572 integrated on a chip that includes the integrated circuits or off chip.

A topology 580 of a configuration of the integrated circuits 560, 562, 564, and 566 is also shown in FIG. 5B. The topology 580 is a graph of functions and interconnections for data and control flow through the configured cores of the integrated circuits 560, 562, 564, and 566. Each box in the topology 580 represents a fractal core in one of the integrated circuits 560, 562, 564, and 566. The topology 580 is placed into multiple integrated circuits that such as integrated circuits 560, 562, 564, and 566 that make up a computational fabric. The topology 580 may thus be mapped to the cores of the integrated circuits 560, 562, 564, and 566. In this example, a set of cores in the integrated circuits 560 and 562 may be configured for concurrent operations such as in an area 582 of the topology. The cores in the other integrated circuits 564 and 566 may be configured for parallelism in an ultra deep pipeline such as in an area 584.

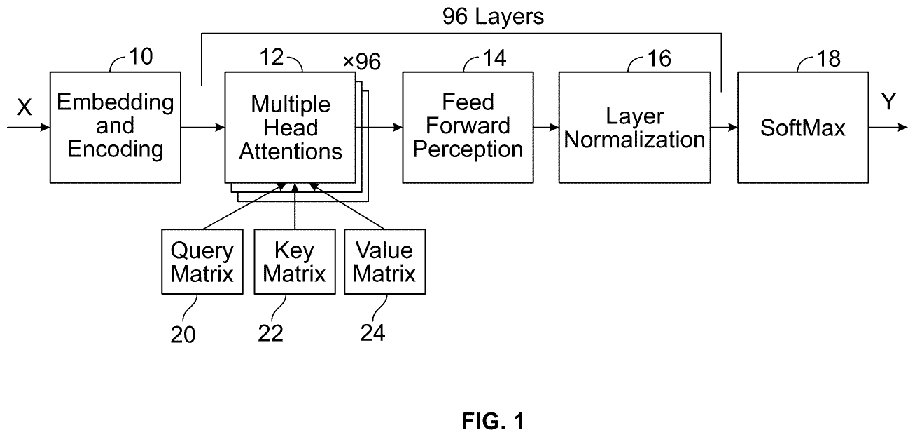

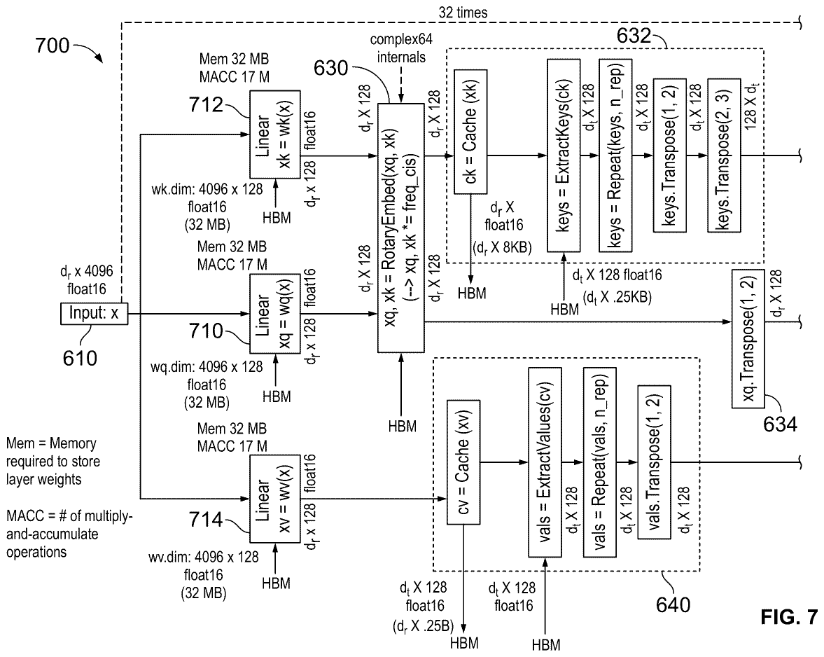

FIG. 6 is a block diagram of a prior art implementation 600 of the head attention function 12 in FIG. 1. As explained above, FIG. 6 shows the Query Matrix 20, a Key Matrix 22, and a Value Matrix 24, which are each calculated for a respective input (x) 610 to determine respective query, key and value decompositions 620, 622, and 624. The computational power and memory required for each of the matrices 20, 22 and 24 is relatively high. For example, 512 MB is required for each of the matrices 20, 22, and 24. 537 GB of multiply and accumulate operations must be performed on each of the matrices 20, 22, and 24 so as to obtain the corresponding matrix solutions query x_{q}, key xₖ, and value xᵥ,. These three matrix solutions are then re-shaped and applied to the next steps of the attention head.

Thus, the query decomposition 620 and key decomposition 622 are fed into a rotatory position embedding function 630. The key output from the rotatory position embedding function 630 is fed into an extract and transpose function 632. The query output from the rotatory position embedding function is fed into a transpose function 634. The outputs of the transpose functions 632 and 634 are fed into a matrix multiplication function 636 that produces a set of scores. The scores are processed and fed into a softmax function 638. The value decomposition 624 is fed into an extraction and transpose function 640. The outputs of the transpose function and the softmax function 638 are fed into a temperature matrix multiplication function 650 that produces temperature values. The temperature values are transposed via a transposer function 652 and fed into a contiguous function 654. The output of the contiguous function 654 is fed into a linear function 656 that provides an output 658 for the attention head.

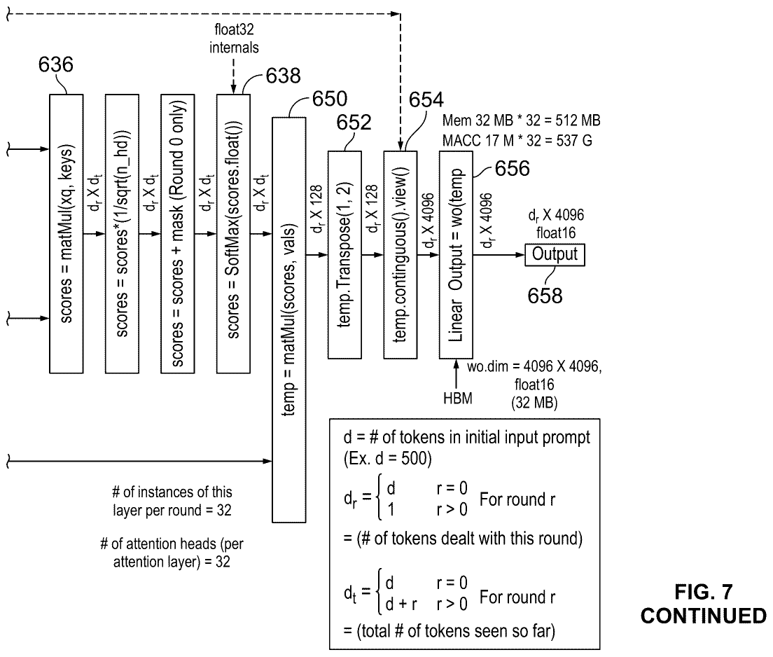

FIG. 7 is a block diagram of an example implementation 700 of the head attention function 12 in FIG. 1. The implementation relies on decomposition of the weight matrices 20, 22 and 24 in the known implementation to respective sub-matrices 710, 712, and 714 to reduce the required memory to 32 MB and 17 MB of multiply and accumulate operations to determine the solutions to the matrices. This process is repeated 32 times to obtain 32 separate submatrix solutions. Multiplications are performed by conducting a linear transform on submatrices 710, 712, and 714 with the input (x) 610. Thus, similar functions in FIG. 6 such as the rotary position embedding function 630, matrix multiplication 636, softmax 638, and matrix multiplication 650 are performed on each of the 32 submatrix solutions. The output of the transposer function 652 for the submatrix is fed to the contiguous function 654, where the input 610 is applied for the particular submatrix. The resulting outputs are applied to the linear function 656 to produce an identical output to the conventional output 658 in FIG. 6.

Unlike the known attention head function in FIG. 6 where the entire weight matrix needs to be accessed and operated by cores in FIGS. 2-5 configured for the matrix calculations, only the sub-matrices 710, 712, 714 and corresponding computations are needed once at each time in FIG. 7. The decomposed sub-matrices 710, 712, 714 have much smaller size and hence offer much more simplicity for configuring the cores in FIGS. 2-5 to access the matrix data and operate calculating the attention head output than the cores that have to process the entire weight matrices in FIG. 6.

The reduction in memory and computation is established for weight matrices: W_{q}, Wₖ, and Wᵥ, (∈R^{L×L}), (matrices 20, 22 and 24) as follows. First, the matrices are decomposed into the following submatrices:

$${W}_{q} = ( \begin{matrix}{W}_{q} ( 1 ) & ⋯ & {W}_{q} ( g )\end{matrix} )$$

$${W}_{k} = ( \begin{matrix}{W}_{k} ( 1 ) & ⋯ & {W}_{k} ( g )\end{matrix} )$$

$${W}_{v} = ( \begin{matrix}{W}_{v} ( 1 ) & ⋯ & {W}_{v} ( g )\end{matrix} )$$

Thus, W_{q}(i), Wₖ(i) Wᵥ(i) (for i=1, . . . g) are submatrices of W_{q} and Wₖ with the dimension L×h, respectively and g×h=L. Thus, for example values of g=32 and h=128, the weight matrices are each L×L or 4,096×4,096 and each of the 32 submatrices are 4,096×128. Thus, the cores in FIGS. 2-5 only need 4,096×128×2=1 MB of memory to operate the submatrices instead of the 32 MB of memory required for the conventional approach in FIG. 6.

After the decomposition, all matrix multiplication and operations are performed on each submatrix with the input x that is:

$$Q ( i ) = x {W}_{q} ( i ) ∈ {R}^{n \times h}$$

$$K ( i ) = x {W}_{k} ( i ) ∈ {R}^{n \times h}$$

$$V ( i ) = x {W}_{V} ( i ) ∈ {R}^{n \times h}$$

which can provide exactly the same result as solving weight matrix after the Re-Shaping processing (as proved in the following):

$$Q = x {W}_{q} = x ( \begin{matrix}{W}_{q} ( 1 ) & ⋯ & {W}_{q} ( g )\end{matrix} ) = ( \begin{matrix}{xW}_{q} ( 1 ) & ⋯ & {xW}_{q} ( g )\end{matrix} )$$

$$K = x {W}_{k} = x ( \begin{matrix}{W}_{k} ( 1 ) & ⋯ & {W}_{k} ( g )\end{matrix} ) = ( \begin{matrix}{xW}_{k} ( 1 ) & ⋯ & {xW}_{k} ( g )\end{matrix} )$$

$$V = x {W}_{v} = x ( \begin{matrix}{W}_{v} ( 1 ) & ⋯ & {W}_{v} ( g )\end{matrix} ) = ( \begin{matrix}{xW}_{v} ( 1 ) & ⋯ & {xW}_{v} ( g )\end{matrix} )$$

Instead of computing the large weight matrices xW_{q}, xWₖ, xWᵥ together once at each step of the process in FIG. 6 by the configured cores in FIGS. 2-5, only sub-matrix operations xW_{q}(i), xWₖ,(i), xWᵥ(i) are required at each step of FIG. 7. Continuing the operations in the functions 630, 632, 634, 636, 638, 650 on these submatrices, the outputs of the last matrix multiplication 650 based on these sub-matrix are simply combined or put together by the “Contiguous” function (concat) 654 and then provided to the linear function 656. This will offer much greater simplicity for configuring the cores in FIGS. 2-5 to implement the functions in FIG. 7 for the 32 smaller submatrices in comparison to the functions in FIG. 6 for the large matrices. The re-shaping in FIG. 6 results in

$$( \begin{matrix}Q ( 1 ) \\ ⋮ \\ Q ( g )\end{matrix} ) = ( \begin{matrix}{xW}_{q} ( 1 ) \\ ⋮ \\ {xW}_{q} ( g )\end{matrix} ) ( \begin{matrix}K ( 1 ) \\ ⋮ \\ K ( g )\end{matrix} ) = ( \begin{matrix}{xW}_{K} ( 1 ) \\ ⋮ \\ {xW}_{K} ( g )\end{matrix} ) ( \begin{matrix}V ( 1 ) \\ ⋮ \\ V ( g )\end{matrix} ) = ( \begin{matrix}{xW}_{v} ( 1 ) \\ ⋮ \\ {xW}_{v} ( g )\end{matrix} )$$

and the desired output u of each attention head is:

$$u = concat ( softmax ( \frac{Q ( i ) {K ( i )}^{T}}{\sqrt{k}} + M ) V ( i ) ) {W}_{o}$$

which is exactly equal to the output provided by the example implementation of FIG. 7:

$$u = concat ( softmax ( \frac{x {W}_{q} ( i ) {W}_{k}^{T} ( i ) {x}^{T}}{\sqrt{k}} + M ) {xW}_{v} ( i ) ) {W}_{o}$$

The example reduction of matrices for efficient reduction of required memory and simplifying core configuration may be used in attention head functions of other transformer based large models such as vision models.

As explained above, the above explained method may be implemented on an example non-transitory computer readable medium including executable instructions which, when executed in a processor, causes the processor to perform the matrix decomposition and other functions in FIG. 7. The computer readable medium may be high bandwidth memory or the internal memory of the configured cores in FIGS. 2-5 themselves. The processor may be a set of the array of cores that may be configured through the executable instructions that allow configuration of the cores as well as routing of data and instructions through the network on chip.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method to perform an attention head function, the method comprising:
decomposing a weight matrix into a plurality of submatrices, each including a set of weights from the weight matrix;
providing an input of the attention head function;
storing one of the plurality of the submatrices in a storage device;
determining a submatrix solution for the submatrix from the input and the set of weights of the submatrix;
repeating the storing and determining a solution for the submatrix for each of the plurality of submatrices to provide a plurality of submatrix solutions; and
combining the resulting plurality of submatrix solutions to obtain a matrix solution for the weight matrix.

2. The method of claim 1, wherein the matrix solution is an input to a large language model.

3. The method of claim 2, wherein the weight matrix is one of a key matrix, a query matrix or a value matrix.

4. The method of claim 1, wherein g submatrices are created, wherein the weight matrix has an L×L dimension, and wherein each of the submatrices has an L×h dimension, and wherein g×h=L.

5. The method of claim 1, wherein the storage device is a high bandwidth memory.

6. The method of claim 1, wherein the determining a submatrix solution is performed by a processing core of a plurality of processing cores.

7. The method of claim 1, wherein the attention head function is part of a transformer based large model.

8. A computer system comprising:
a memory;
an input accepting an input to an attention head function;
a processor coupled to the input and the memory, the processor configured to:
decompose a weight matrix into a plurality of submatrices, each including a set of weights from the weight matrix;
store a set of weights from one of the submatrices in the memory;
determine a submatrix solution for the submatrix from the input and the set of weights of the submatrix;
repeat the storing a set of weights and determining a solution for the submatrix for each of the plurality of submatrices to provide a plurality of submatrix solutions; and
combine the resulting plurality of submatrix solutions to obtain a matrix solution for the weight matrix.

9. The computer system of claim 8, wherein the processor includes a plurality of identical configurable processing cores and a network interconnecting the plurality of identical configurable processing cores.

10. The computer system of claim 8, wherein the matrix solution is an input to a large language model.

11. The computer system of claim 10, wherein the weight matrix is one of a key matrix, a query matrix or a value matrix.

12. The computer system of claim 8, wherein g submatrices are created, wherein the weight matrix has an L×L dimension, and wherein each of the submatrices has an L×h dimension, and wherein g×h=L.

13. The computer system of claim 8, wherein the memory is a high bandwidth memory.

14. The computer system of claim 8, wherein the attention head function is part of a transformer based large model.

15. A non-transitory computer readable medium including executable instructions which, when executed in a processor, causes the processor to:
decompose a weight matrix into a plurality of submatrices, each including a set of weights from the weight matrix;
store a set of weights from one of the submatrices in a memory;
receive an input to an attention head function;
determine a submatrix solution for the submatrix from the input and the set of weights of the submatrix;
repeat the storing a set of weights and determining a solution for the submatrix for each of the plurality of submatrices to provide a plurality of submatrix solutions; and
combine the resulting plurality of submatrix solutions to obtain a matrix solution for the weight matrix.

16. The non-transitory computer readable medium of claim 15, wherein the processor includes a plurality of identical configurable processing cores and a network interconnecting the plurality of identical configurable processing cores, wherein the instructions configure the configurable processing cores.
